(19) United States
(12) Patent Application Publication
(10) Pub. No.: US 2017/0140220 A1
(43) Pub. Date: May 18, 2017

(54) System for Identifying a Photographic Camera Model Associated with a JPEG-Compressed Image, and Associated Method, Uses and Applications

(71) Applicant: Universite de Technologie de Troyes, Troyes, Cedex (FR)

(72) Inventors: Rémi COGRANNE, Chamoy (FR); Florent RETRAINT, Courteranges (FR); Thanh Hai THAI, Troyes, Cedex (FR)

(21) Appl. No.: 15/300,094

(22) PCT Filed: Mar. 27, 2015
(86) PCT No.: PCT/FR2015/050806

§ 371 Date: Sep. 28, 2016

(30) Foreign Application Priority Data
Mar. 28, 2014 (FR) 1400767

(51) Int. Cl. G06K 9/00; G06K 9/62

(52) U.S. Cl. CPC G06K 9/00577; G06K 9/6202; G06K 2009/00583

(57) ABSTRACT

A system and method are described for identifying a photographic camera model from a photograph taking the form of an optionally TIFF-compressed image and fulfilling a relationship between the expectation and the variance of the pixels of the image. This relationship is dependent, inter alia, on two parameters, “c” and “d”, and these two parameters determine a fingerprint characterising the camera model. The system includes an image processing device that can process the photograph to estimate parameters “c” and “d”. The system also includes a device for carrying out statistical hypothesis tests on the distribution of the pixels of the photograph and a statistical analysis device for determining if the photograph was taken by the camera model by comparing the “c” and “d” parameters obtained from the photograph and the known “c” and “d” parameters of the camera model.

### 1. TECHNICAL FIELD OF THE INVENTION

The invention pertains to the identification of a photographic camera model, more particularly, the invention relates to a system for determining the identification of a photographic camera model on the basis of a digital photograph having undergone the whole set of processings of the acquisition chain, or indeed compressed according to the JPEG standard. The invention also relates to a method for implementing such a system. These systems find significant applications in determining the provenance of a photograph.

Digital forensics or the search for proofs in a digital medium has undergone significant development over the last decade. In this field, proposed procedures fall into two categories depending on whether one wishes to identify the photographic camera model or the camera itself (an instance of a certain model).

Generally, identification procedures are passive or active. In the case of active procedures, the digital data representing the content of the image are modified so as to insert an identifier (so-called watermarking procedure). When the inspected image does not contain any watermark, the acquisition camera must be identified on the basis of the data of the image.

### 2. PRIOR ART

Two key problems are identified in relation to forensics: identification of the origin of the image and detection of false images (see [1] and the references incorporated into this document). Identification of the origin of the image is aimed at verifying whether a given digital image is acquired by a specific photographic camera (i.e. an instance) and/or at determining its model. The detection of false images is aimed at detecting any act of manipulation such as splicing, removal or addition in an image. Two approaches, active and passive, exist for solving these problems. Digital watermarking is considered to be an active approach. There are nonetheless a few limitations [1] since the incorporation mechanism must be available, and the credibility of the information incorporated in the image remains arguable. The passive approach has been increasingly studied in the last decade. The watermark, or the prior information of the image, including the availability of the original image, is not required in its mode of operation.

Passive forensics procedures rely on the fingerprints of the photographic camera, left in the image, to identify its origin and verify its authenticity. These prints are extracted by the image acquisition processing chain; see references [2]-[4], for an insight into the various steps and the structure of the various processing within a digital photographic camera.

The passive forensics procedures proposed for solving the problem of identifying the origin of the image can be divided between the following two fundamental categories.

The procedure of the first category is based on the hypothesis that differences exist between the models of cameras, whether in respect of the image processing techniques and in respect of the technological components. Indeed, the aberration of the objective cf. [5], the “Color Filter Array” (CFA), the interpolation algorithm, dematrixing cf. [6]-[8], and JPEG compression see [9] are considered to be influential factors in identifying the model of the photographic camera when white balancing algorithms, see [10], are used for identifying the source camera. On the basis of these factors, a set of functionalities is provided and used in the automatic learning algorithm. The main concern is that the image processing techniques remain identical or similar and, the components, produced by a few manufacturers, are distributed between the models of photographic cameras. Moreover, as in all automatic learning techniques, it is difficult to construct a set of discriminating characteristics. Furthermore, the analysis of detection performance remains an open problem cf. [11].

The procedure of the second category is aimed at identifying the unique characteristics, or fingerprints, of the acquisition camera. The “Sensor Pattern Noise” (SPN) or characteristic noise of a sensor, is based on the imperfections resulting from the process for manufacturing the photographic sensor and on the non-uniformity during electronic conversion of the photo because of the lack of homogeneity of the silicon wafers (also called “Photo-Response Non-Uniformity” or PRNU). This is a unique fingerprint, see references [12]-[17]. Moreover, the procedures based on the presence of non-uniformity noise (PRNU) are also used for identifying the model of the photographic camera. These procedures are based on the hypothesis that the fingerprint obtained on the basis of an image in the TIFF or JPEG format contains traces of the intrinsic watermark, namely the SPN containing information about the model of the photographic camera.

It should be noted that the two main components of the Sensor Pattern Noise SPN are the “Fixed Noise Pattern” (FPN) and the “Photo-Response Non-Uniformity” PRNU. The FPN, or “fixed shape noise structure”, which is used in reference [19] for identifying the camera, is generally compensated for in a photographic camera by subtracting a dark image on the output image. Consequently, the Fixed Noise Pattern (FPN) is not a robust fingerprint and will not be able to be used in subsequent works. The PRNU is utilized directly in certain works, see references [13], [14], [17]. The ability to reliably extract this noise from the image is the main challenge in this category. Another challenge is the falsification of the origin of the image due to “counter-analysis” activities, see reference [20]. However, the existing procedures are designed with very limited utilization of the theory of hypothesis testing and statistical image models. Consequently, their performance is not yet analytically established.

Most known medical imaging procedures are based on the noise of the sensors, see references [18], [21], or on characteristics geared toward the operations in the photographic camera, see references [6], [8]. Most digital photographic cameras export images in the JPEG format. The ability to extract image characteristics is placed in doubt because the JPEG compression may seriously damage these characteristics. In the patent application referenced as [21] we have proposed to utilize the parameters (a, b) to passively identify a photographic camera model. This procedure is based on the heteroscedasticity of the noise present in a RAW image. A RAW image is an image that has not undergone any of the post-acquisition processings of the recording chain. Document [21] shows perfect detection performance for the identification of a photographic camera model on the basis of the RAW images, of uncompressed images or of lossless compressed images. However, it is useful to extend this procedure to TIFF or JPEG format compressed images.

The issue tackled in the present invention is that of the passive identification of an acquisition photographic camera model on the basis of a photograph in the given compressed image form. Passive identification is understood to mean taking a decision in the case where the photograph or the image is not assumed to contain any information identifying its source. The problems that it is envisaged to solve are 1) to ensure that a photograph has not been taken by a given camera when the photograph is compromising or, 2) conversely, to guarantee that an inspected photograph has indeed been taken by one camera rather than by another. The examples of application are numerous, including: is this photographic camera responsible for the photograph of the confidential document (such as those available on wikileaks); could a given photograph of a pedopornographic nature have been acquired with the photographic camera of a suspect; has the copy of a contract been scanned with the client's camera; the photograph of a document makes it possible to copy and mark the document etc.

### 3. DISCLOSURE OF THE INVENTION

The aim of the invention is to provide a system for identifying a photographic camera model on the basis of a photograph in the form of a compressed image or in an uncompressed format of TIFF type, said photograph obeying a relation between the expectation and the variance of the pixels such that:

$${σ}_{{z}_{i}}^{2} = \frac{1}{{γ}^{2}} {μ}_{{z}_{i}}^{2 - 2 γ} ( c {μ}_{{z}_{i}}^{γ} + d ) + \frac{{Δ}^{2}}{12}$$

where zᵢ is the pixel, Δ is the step size, fixed by said photographic camera, of a quantization of said photograph, μ_{zi} and σ_{zi}² designate respectively the expectation and the mathematical variance of a pixel zᵢ, γ is the gamma correction parameter, fixed by said photographic camera, and the parameters (c, d) of the relation determine fingerprints characterizing said photographic camera model,
   the system is characterized in that it comprises an image processing device able to process said photograph so as to estimate the parameters ‘c’ and ‘d’ and in that the system furthermore comprises a device for executing statistical hypothesis tests on the distribution of the pixels of said photograph and a statistical analysis device so as to determine whether said photograph has been taken by said photographic camera model by comparing the parameters ‘c’ and ‘d’ arising from said photograph and the known parameters ‘c’ and ‘d’ of said photographic camera model.

Advantageously, the analysis device provides an indication about the identification of said photographic camera model by certifying the accuracy of the identification with a previously defined precision.

The invention further relates to a method implemented in the identification system hereinabove. The method is characterized in that it comprises the following steps:
prior analysis of at least one photograph acquired with a known photographic camera model with a view to estimating the print parameters ‘c’ and ‘d’ of said photographic camera model,
reading of a photograph in the form of a compressed image with a view to determining the matrices of the value of the pixels,
estimation of a generalized noise model for said compressed image, by taking account of the ‘gamma correction’ parameter,
estimation of the parameters of the generalized noise model,
   detection of the contours;
   segmentation of said compressed image,
execution of statistical hypothesis tests with a view to identifying a photographic camera model.

Advantageously, the statistical hypothesis tests are executed as a function of a prescribed constraint on the probability of error.

According to one embodiment of the invention, the photograph is in a non-compressed format of TIFF type.

According to the invention, the photograph is a compressed image, according to the JPEG compression standard arising from a photographic camera or from a scanner.

Advantageously, the photograph is a reference, or inter-frame, image belonging to the video stream, and compressed according to the MPEG compression standard.

The invention further relates to the use of the method hereinabove for the detection in an unsupervised manner of the falsification of a zone of a photograph.

Moreover, the invention relates to the use of the method hereinabove for the detection, in a supervised manner, of the falsification of a zone of a photograph. This detection is carried out by testing whether an a priori known zone originates from the same photographic camera as the remainder of the inspected image.

The invention further relates to the use of the method hereinabove in the search for proofs on the basis of a compromising image.

The invention relates to the application of the method hereinabove in specialized software, in the search for proofs on the basis of digital media.

### 4. BRIEF DESCRIPTION OF THE FIGURES

Other characteristics, details and advantages of the invention will emerge on reading the description which follows, with reference to the appended figures, which illustrate:

FIG. 1 shows a system for determining the identification of a photographic camera model in accordance with the invention;

FIG. 2 illustrates the post-acquisition processing chain used in the digital photographic cameras;

FIG. 3 shows the estimated parameters (c, d) of the JPEG images arising from the Canon Ixus 70 photographic camera with various settings of the camera;

FIG. 4 shows the estimated parameters (c,d) of the JPEG images arising from various cameras of the same Canon Ixus 70 model;

FIG. 5 shows the estimated parameters (c,d) of the JPEG images arising from various models of photographic cameras;

FIG. 6 illustrates the dispersion diagram of the expectation and the variance of the pixels on the basis of the JPEG images arising from the Nikon D70 and Nikon D200 photographic cameras;

FIG. 7 shows the empirical distribution of the residuals Z in a segment, compared with the theoretical Gaussian distribution;

FIG. 8 shows the detection performance of the proposed tests for 50 and 100 pixels extracted randomly from JPEG images, simulated with a quality factor of 100;

FIG. 9 shows the detection performance of the proposed test (GLRT) for 100 pixels extracted randomly from the JPEG images, simulated with different quality factors;

FIG. 10 shows the detection performance of the GLRT for 50 and 100 pixels extracted randomly from the JPEG images of a Nikon D70 camera and of a Nikon D200 camera;

FIG. 11 illustrates the comparison between the theoretical false alarm probability (FAP) and the empirical FAP, plotted as a function of the decision threshold t;

Table 1 illustrates the estimation of the parameters on synthesis images;

Table 2 illustrates the models of the photographic cameras used for the experiments.

For greater clarity, identical or similar elements are tagged by identical reference signs in all the figures.

### 5. DETAILED DESCRIPTION OF AN EMBODIMENT

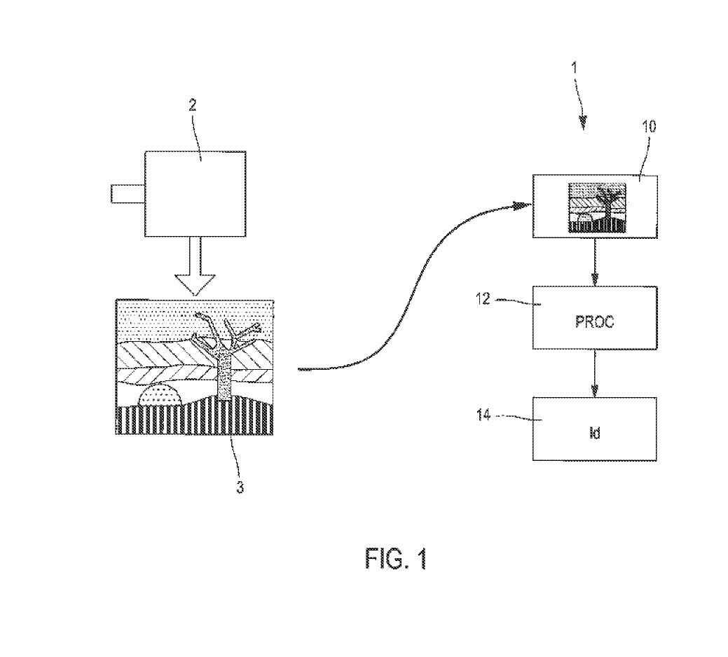

FIG. 1 represents a system 1 for determining the identification of a photographic camera. The reference 1 indicates the system and the reference 2 the photographic camera which has taken a photograph 3.

It is on the basis of this photograph 3 that the system 1 will determine the photographic camera model that took this photograph. This system is composed of a photo analyzer which will examine this photograph 3. The photograph 3 takes the form of a compressed image suitable for the processing which will follow. The formats of JPEG or TIFF type (file format for digital images) are formats suitable for this processing. Format of JPEG type is understood to mean an image file, compressed according to the JPEG standard. The compressed image arises from photograph acquisition cameras such as a photographic camera or a scanner.

The system 1 can be implemented on a computer of PC type. This system 1 is furnished with an input facility 10 so as to enter the data of the photograph 3. These data are processed by a processing device 12 which implements a processing which will be explained hereinbelow. A device for executing statistical hypothesis tests on the distribution of the pixels and a statistical analysis device 14 will provide an indication about the identification of the photographic camera model responsible for said photograph.

According to the method in accordance with the invention, in the first step, the digital photograph 3 is viewed as one or more matrices whose elements represent the value of each of the pixels. In the case of a gray level image, the photograph can be represented by a single matrix which, for the sake of clarity, will be Z=zᵢ with 1≦i≦L corresponding to the value of the components of the matrix according to a lexicographic reading order. For color images, three distinct colors are usually used: red, green and blue. In this case, an image may be regarded as 3 distinct matrices, one matrix per color channel: Z=zᵢ^{k} with 1≦k≦3

The second step of the method consists in separating the various color channels, when the analyzed image is in color. The series of operations being carried out in an identical manner with each of the matrices representing the color channels, we consider that the image is represented by a single matrix (the index k is omitted).

Noise present in digital photographs exhibits the property of being heteroscedastic: The (random) stochastic properties of noise are not constant over the whole set of pixels of the image.

Because of the large number of photons incident on the sensors, it is possible to approximate with high precision the process of counting by a Gaussian random variable.

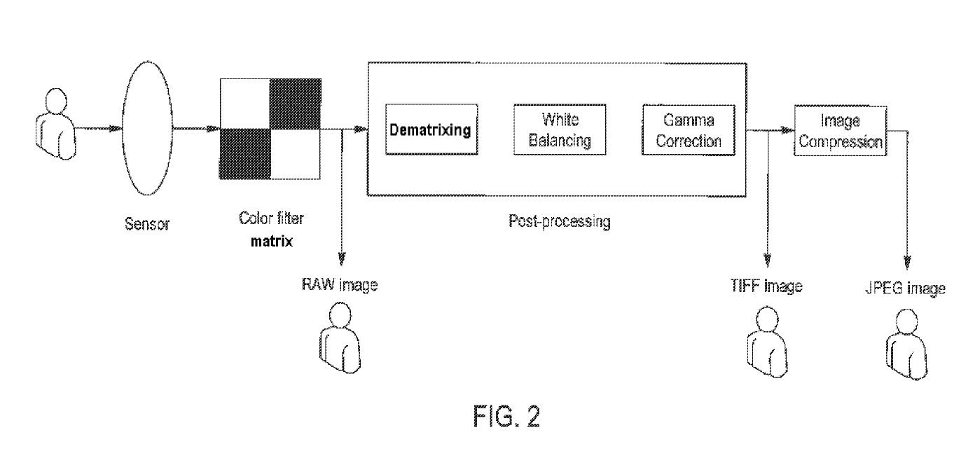

FIG. 2 illustrates the whole of the post-acquisition processing chain in digital photographic cameras. This acquisition chain comprises several processing steps (dematrixing, white balancing, and gamma correction) subsequent to which a polychromatic image is obtained on the basis of the luminous intensity measured by each photosensitive cell of the sensor. According to the procedure of each step, the quality of the final image can vary appreciably. Each step affects the final output image. It should be noted that the sequence of operations differs from one manufacturer to another.

In the patent application reference [21], the parameters (a,b) were utilized to identify in a passive manner a photographic camera model, where a and b are two parameters characteristic of a photographic camera. This procedure is based on the heteroscedasticity of the noise present in a RAW image. The (random) stochastic properties of noise are not constant over the whole set of pixels of the image. More precisely, the value of each pixel depends linearly on the number of incident photons. This model, which represents all the noise corrupting the RAW image during its capture, but before post-acquisition processings, gives the variance of the noise as a linear function of the mathematical expectation of the pixels and obeys the following relation:

yi˜ [symbol] (μ_{yi},aμ_{yi}+b) (1)

where yi is the value of the RAW pixel, i is the pixel index, and, μₓ, and σ²ₓ designate respectively the expectation and the mathematical variance of a random variable x. Even though this procedure shows almost perfect detection performance, there are two main limitations. Firstly, it concentrates on the RAW images, which may not be available in practice. Indeed, the most difficult part when extending this procedure to other image formats, for example TIFF and JPEG, is the impact of the post-acquisition method (dematrixing, white balancing and gamma correction) as well as of the compression method, since the dematrixing causes spatial correlation between the pixels and the non-linear operations destroy the linear relation between the expectation and the variance of the pixel. Secondly, the proposed fingerprint, defined by the parameters (a, b), depends on the ISO sensitivity. Now, for a photographic camera this is not crucial since there is not much ISO sensitivity and a small number of images is sufficient to estimate the reference parameters (a, b) for each ISO sensitivity. Consequently, it is desirable to count on a print which is invariant with respect to the content of the image and which is robust for the nonlinear transformation operations (for example the gamma correction parameter).

To render a color image complete on output and improve its visual quality, a RAW image requires a post-acquisition process, for example, dematrixing, white balancing, and gamma correction. To extend the method referenced in [21] to TIFF images, let us assume that the effect of the algorithm for dematrixing and white balancing is negligible on the heteroscedastic relation of the expectation and of the variance of the pixel.

σ_{yi}²=cμ_{yi}+d (2)

where, to simplify the notation, yᵢ is referenced to the balanced white pixel. The parameters (c, d), in equation (2), differ from the parameters (a, b) of equation (1) because of the dematrixing and white balancing operations. Nonetheless, the relation between the expectation and the variance of the balanced white pixel remains linear. For the sake of simplification, the color channel index is omitted and the gamma correction is defined by the following transformation, applied element by element:

$${z}_{i} = {y}_{i}^{\frac{1}{γ}} = {( {μ}_{{y}_{i}} + {η}_{{y}_{i}} )}^{\frac{1}{γ}} = {{μ}_{{y}_{i}}^{\frac{1}{γ}} ( 1 + \frac{{η}_{{y}_{i}}}{{μ}_{{y}_{i}}} )}^{\frac{1}{γ}} \qquad ( 3 )$$

in this relation y is the correction parameter (typically, γ=2.2) and η_{yi} is a zero-mean signal, corresponding to the Gaussian acquisition noise, after dematrixing and white balancing. The first order of the Taylor series expansion of (1+x)^{(1/γ)} for x=0 leads to:

$$\begin{matrix}{z}_{i} = {μ}_{{y}_{i}}^{\frac{1}{γ}} + \frac{1}{γ} {μ}_{{y}_{i}}^{\frac{1}{γ} - 1} {η}_{{y}_{i}} + o ( \frac{{η}_{{y}_{i}}}{{μ}_{{y}_{i}}} ) \\ \approx {μ}_{{z}_{i}} + \frac{1}{γ} {μ}_{{z}_{i}}^{1 - γ} {η}_{{y}_{i}}\end{matrix} \qquad ( 4 )$$

where

$${u}_{{z}_{i}} = {μ}_{{y}_{i}}^{\frac{1}{γ}}$$

is the expectation of the pixel after applying the gamma correction, whose value is denoted “zᵢ”. Taking the expectation and the variance on both sides of equation (4), we obtain:

$${σ}_{{z}_{i}}^{2} = \frac{1}{{γ}^{2}} {μ}_{{z}_{i}}^{2 - 2 γ} {σ}_{{η}_{{y}_{i}}}^{2} = \frac{1}{{γ}^{2}} {μ}_{{z}_{i}}^{2 - 2 γ} ( c {μ}_{{z}_{i}}^{γ} + d ) \qquad ( 5 )$$

Furthermore, the corrected gamma image undergoes the quantization Q_{Δ} with Δ the quantization step size fixed by the photographic camera. With the hypotheses of document [22], the quantization of the noise can be modeled by an additive noise which is uniformly distributed and uncorrelated with the input signal. By taking account of the variance of the quantization of the noise, we obtain the generalized model of the noise in a photograph in the form of a compressed image:

$${σ}_{{z}_{i}}^{2} = \frac{1}{{γ}^{2}} {μ}_{{z}_{i}}^{2 - 2 γ} ( c {μ}_{{z}_{i}}^{γ} + d ) + \frac{{Δ}^{2}}{12} \qquad ( 6 )$$

where zᵢ designates a pixel of the final TIFF format image. To simplify, let us assume that the step size of the quantization is unitary, that is to say Δ=1. Now, relation (6) hereinabove is denoted by the function f(•): σ²_{zi}=f (μ_{zi}|c, d, γ). This model, defined by equation (6), will be utilized for the identification of a photographic camera model. Moreover, this generalized noise model is more precise with respect to the non-linear noise model used in the documents referenced as [23], [24].

Moreover, JPEG compression is a key post-processing operation which is customarily implemented in a digital photographic camera. The distortions caused by the compression can interfere with the estimation of the parameters. Consequently, it is desirable to evaluate the accuracy of the estimation with various quality factors. Table 1 shows the mean and the standard deviation of the estimated parameters for the uncompressed TIFF images and for the compressed JPEG images, with the quality factors {70, 80, 90}. The parameters (c, d, γ) used to generate synthesis images are estimated on the basis of the JPEG images compressed with Nikon D70 and Nikon D200 cameras.

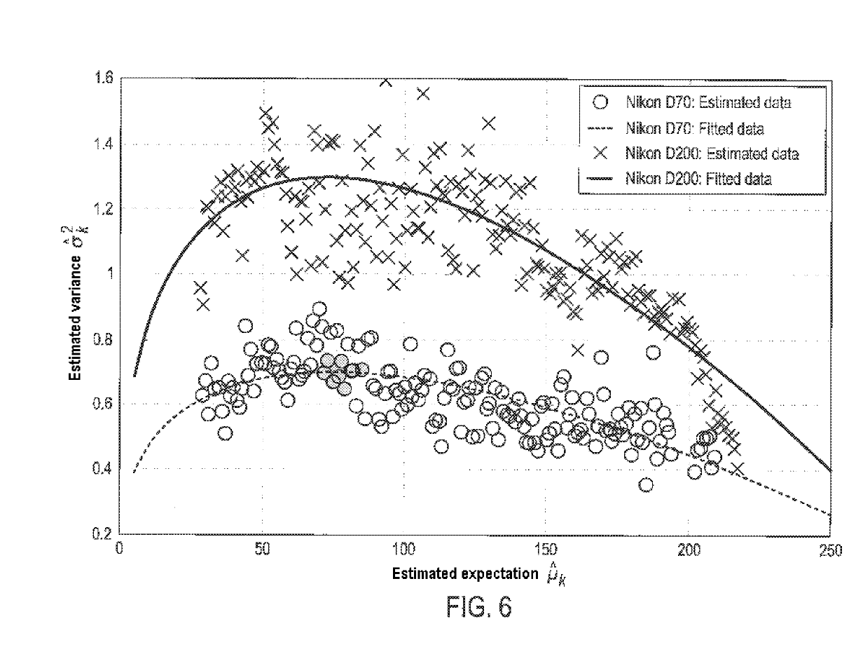

FIG. 6 illustrates the generalized noise model (6) of the photographs in the form of compressed JPEG images arising from the Nikon D70 and Nikon D200 cameras. The images are extracted from the Dresden image database [25]. Use is also made of TID2008 database reference images [26] which cover the various scenes imaged to generate synthesis images, compressed with imagemagick. The present invention processes only JPEG images with quality factors of typically greater than 60.

For the problem of identifying the model of the photographic camera, it is necessary to evaluate the variability of the parameters (c, d) of the photographic camera for the various settings of the camera and the various devices per camera model, and to verify their discriminability for various models of photographic cameras.

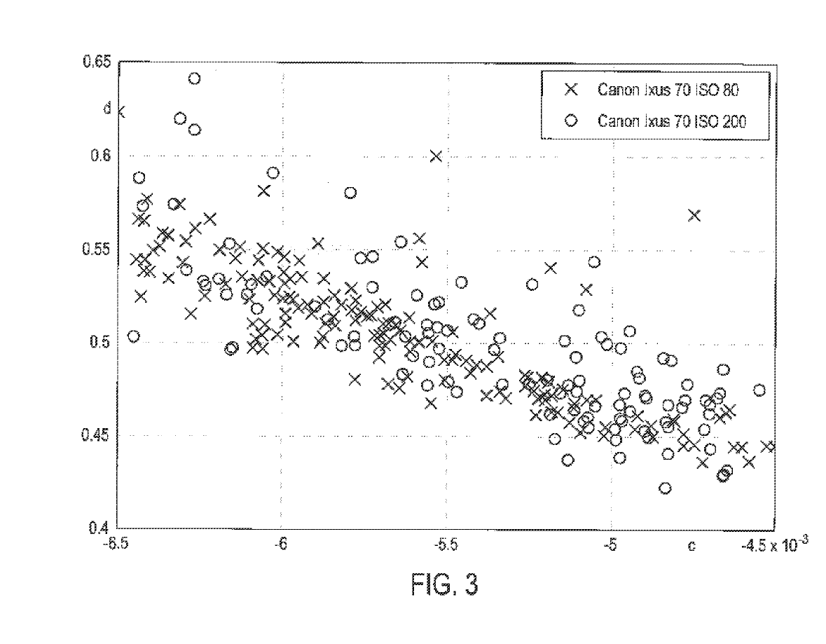

FIG. 3 represents the parameters (c, d) estimated on the basis of the JPEG images from a Canon Ixus 70 photographic camera, obtained with various settings of the camera, namely ISO 80 and ISO 200.

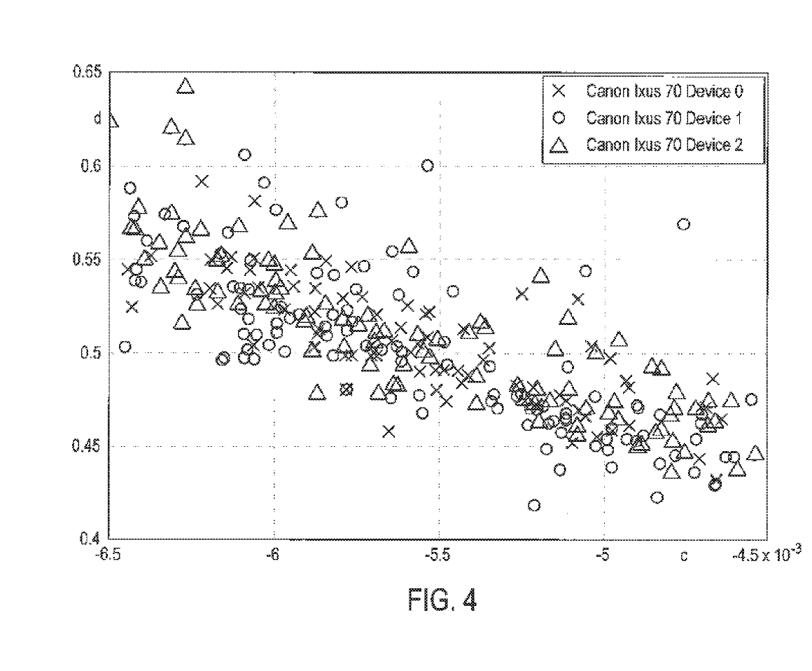

FIG. 4 illustrates the stability of the estimated parameters for various instances of the same Canon Ixus 70 photographic camera model; the settings in terms of ISO sensitivities being different for the photographs considered.

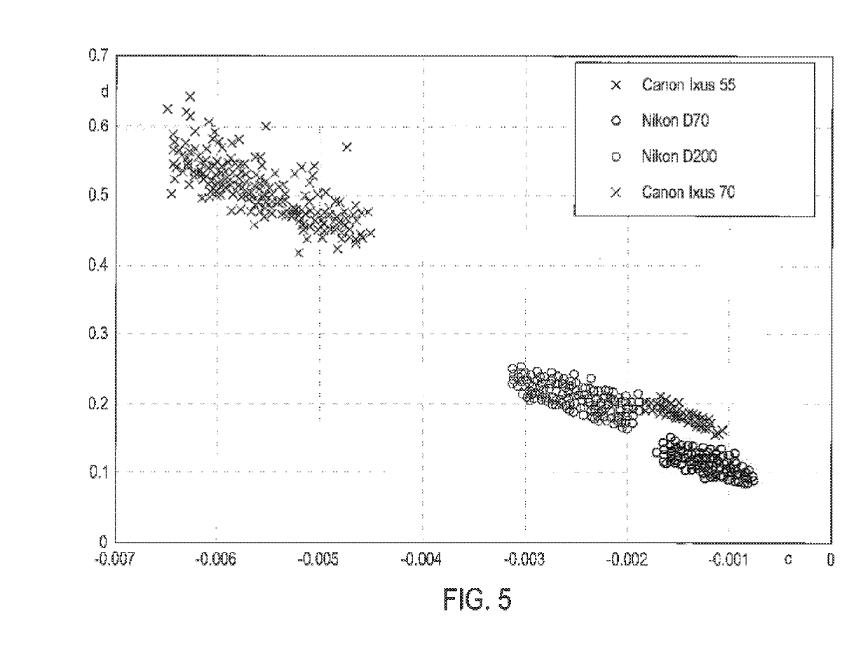

FIG. 5 illustrates the discriminability of the parameters for various models of photographic cameras. Note that the parameters (c, d) are invariants of the image scene and of the photographic camera. They are robust for the non-linear post-acquisition method and discriminatory for various models of photographic cameras. These parameters can be utilized as unique fingerprints to identify the models of photographic cameras.

The third step of the method according to the invention relates to the estimation of the parameters of the noise model on the basis of a non-compressed image that was subject to the set of post-acquisition processings or on the basis of a compressed image in the JPEG format. The generalized noise model of relation (6) is nonlinear, thus causing a difficulty in estimating the parameters of the model. When the gamma correction parameter is known in advance, an obvious approach is to invert this gamma correction parameter to re-obtain the heteroscedasticity of the noise model (2) and then to perform weighted least squares (WLS), an approach proposed in [21]. However, this approach leads to numerous problems in practice see reference [27]. Firstly, because the gamma correction parameter cannot be known in advance since it is determined experimentally by involving a calibration target with a complete range of known luminance, but, such a calibration is not available in practice. Another method for estimating the gamma correction factor without any calibration information or any imaging device knowledge has been proposed in reference [28]. However, the stability of this method on a large database of real images is still questionable. Secondly, even when the value of the gamma correction factor is known exactly, the effect of the quantization of the noise Q_{Δ} renders the inversion of the gamma correction into a poor condition. Finally, this nonlinear inversion introduces undesirable spatial information into the signal, thus preventing a good estimation of the parameters from being obtained.

The aim of the invention is to give a methodology for estimating the parameters of the model which operates directly on the non-linear generalized noise model (6).

Moreover, the estimation of the parameters of the noise model can be performed on the basis of one or more images. We concentrate here on the automatic estimation of the noise parameters on the basis of a single image. Indeed, the numerous procedures presented in documents [21], [23], [24], [29], relating to the estimation of the parameters of the noise, rely on basic measurements which are similar but which differ in the details. In these documents, the variance of the noise is represented as a function of the content of the image. The methodologies begin on the basis of locally obtaining the variance of the noise and the content of the estimated image, by effecting the curve for fitting the dispersion diagram, based on prior knowledge of the noise model. These existing techniques comprise two main difficulties:—the influence of the content of the image and—the spatial correlation of the noise in the images. In fact, the homogeneous regions, where the local variances and means are estimated, are obtained by performing edge (contour) detection and image segmentation. However, in these homogeneous regions, the accuracy of these local estimations could be contaminated because of the presence of aberrant values (textures, the details and the edges). Furthermore, because of the spatial correlation, the local estimations of the variance of the noise are generally overestimated. Overall, the two difficulties may be manifested through the inaccuracy in estimating the parameters of the noise.

The procedure of the present invention is also based on measures such as the segmentation of an image, edge detection, the study of an isolated case of dispersion diagram fitting curve. This procedure makes it possible to estimate the parameters of the model without requiring any prior knowledge of the type of noise. A first preprocessing step, which consists of a partitioning into 64 sub-images, precedes estimation so as to avoid the effect of the JPEG compression algorithm, which operates separately on each of the blocks of a constant size of 8×8 pixels, as well as the spatial correlation between the pixels in a compressed image. It is assumed that the spatial correlation between the pixels of each sub-image is negligible so that the pixels are assumed independent. This preprocessing step can make it possible to provide estimations of more precise regional parameters in the homogeneous image regions.

In the second step the detection of the contours and the segmentation of images are undertaken. Consider a JPEG image Z, to improve the precision of the segmentation, we perform an estimation of the structure of the image by using a denoising filter [symbol] : Z^{app}= [symbol] (Z) where Z^{app} is an approximate image structure. The residual image Z^{res} is the difference between the noisy image Z and the denoised image Z^{app}. Said residual image Z^{res} is considered in the guise of structure of the noise, and will furthermore be used to estimate the variances of the local noise. The denoising filter [symbol] used is based on wavelets, because of its relative precision and its efficiency of calculation, see the references (see [12], [30]). The image Z, consequently, Z^{app} and Z^{res}, are arranged as 64 vectors of pixels z_{L}=(z_{L,1}, . . . Z_{L,N}), where Lε{1, . . . 64} is the location of the index in the grid of 8×8 pixels and N is the block number or index. Consequently, the vector zₖ contains all the pixels at the same location of the 8×8 grid and the pixels (z_{1,B}, . . . , Z_{64,B}) are in the same block [symbol] .

For the contour detection, instead of identifying pixels for which a local discontinuity exists, one aims rather more at identifying whether an 8×8 block is homogeneous or else whether it contains a contour or a discontinuity. The detection of the homogeneous blocks is also crucial because the estimation of the parameters of the above generalized noise model relies on them. To this end, we calculate the standard deviation of each block and compare it with the global standard deviation. To calculate the standard deviation of each block, we use the median of the absolute value about the mean (MAD) which is considered to be a robust estimation of the standard deviation. Moreover, to attenuate the spatial correlation between the pixels of each block, the discrete cosine transform (DCT), which is considered to be a sub-optimal transformation offering good decorrelation, is used for the calculation of the standard deviation.

Consequently, the estimation of the standard deviation of each block B is given by

ŝ_{B}=MAD(DCT(z_{1,B}^{app}, . . . ,z_{64,B}^{app})) (7)

Only 63 coefficients are used in relation (7). The DC coefficient is excluded. The global standard deviation is calculated as the median of the absolute value about the mean (MAD) of all the residual pixels Zᵢ^{res}

ŝ=MAD(Z^{res}) (8)

Now, if a contour disturbs an 8×8 block, the local standard deviation Ŝ_{B} would be high. We use the global standard deviation ŝ as an adaptive threshold. Consequently, the set of homogeneous blocks is defined by:

S={1≦B≦N:ŝ_{B}≦ŝ} (9)

Certain weak contours might not be detected with this method. Consequently, it is proposed to sort the estimated standard deviation, ŝ_{B}, of the blocks selected hereinabove, in decreasing order and to choose 80% of the number of blocks for the subsequent operations. The other blocks are excluded from the set S. After detection of the homogeneous blocks, the image is divided into K non-overlapping segments. The approximate structure of the image is used for the segmentation. The idea is that the pixels whose denoised value takes the same gray level are independent and identically distributed. Furthermore, to avoid the effect of the JPEG compression, we use only a sub-image, that is to say a vector Z_{L}. In fact, the noise quantization introduced in the DCT domain is not spatially invariant and the error quantization is higher for the pixels near the boundaries of blocks. Consequently, we choose the sub-image, z_{L} corresponding to the location (4,4) of the grid. Each segment Sₖ with, kε{1, . . . K} is defined by:

$${S}_{k} = \{ {z}_{L , B} \text{:} {z}_{L , B}^{app} ∈ [ {u}_{k} - \frac{{Δ}_{k}}{2} , {u}_{k} + \frac{{Δ}_{k}}{2} [ , B ∈ S \} \qquad ( 10 )$$

Stated otherwise, the dynamic range of the image is uniformly divided into K intervals of length Δₖ. The number of segments K used is adjusted in relation to the number of quantization levels, for example K=2⁸ for a quantization on 8 bits, and Δₖ=1. It should be noted that the denoising filter estimates the intensities of the denoised pixels on the basis of local information around each pixel. Thus, the denoising filter creates an artificial correlation between the denoised pixels, thus impeding the estimation of the variance of the noise in each segment. The use of a sub-image also decreases the effect caused by the denoising filter. Consequently, the pixels in each segment Sₖ are assumed to be independent and identically distributed. For the sake of clarity, the pixel of each segment Sₖ is now denoted; z_{k,i}, i={1, . . . nₖ} where nₖ is the number of pixels in the segment Sₖ. In an analogous manner, z_{k;i}^{app} and z_{k;i}^{res} designate respectively its denoised value and its residual value.

Consequently, the local mean and the local variance of each segment are given by:

$$\begin{matrix}{\hat{μ}}_{k} = \frac{1}{{n}_{k}} {\sum }_{i = 1}^{{n}_{k}} {z}_{k , i}^{app} & ( 11 ) \\ {\hat{σ}}_{k}^{2} = \frac{1}{{n}_{k} - 1} {\sum }_{i = 1}^{{n}_{k}} {( {z}_{k , i}^{res} - {\overline{z}}_{k}^{res} )}^{2} with {\overline{z}}_{k}^{res} = \frac{1}{{n}_{k}} {\sum }_{i = 1}^{{n}_{k}} {z}_{k , i}^{res} & ( 12 )\end{matrix}$$

Since the local mean (̂μ_{K}) is calculated as the mean of all the denoised values of each segment, it is assumed that its variance is negligible, i.e. the local mean ̂μ_{K} is very close to the true value ̂μ_{K}: ̂μ_{K}≈μ_{K}. But, the variance of (̂δₖ²) is more crucial and must be processed with care. According to Lindeberg's central limit theorem (CLT) [31, theorem 11.2.5], for a very large number of pixels nₖ, the local variance \hat{σ}ₖ² follows the Gaussian distribution

$${\hat{σ}}_{k}^{2} \sim 𝒩 ( {σ}_{k}^{2} , {d}_{k} {σ}_{k}^{4} ) with {d}_{k} = \frac{2}{{n}_{k}} \qquad ( 13 )$$

where \hat{σ}ₖ²=f(μₖ|c, d, γ) is the real variance in regard to μ_{K}.

The Maximum Likelihood (ML) approach is used to fit the global parametric model \hat{σ}ₖ²=f(μ_{K}|c, d, γ), for the set of points of the pairs {̂μ_{K}; \hat{σ}ₖ²}^{K}ₖ₌₁. The logarithm of the likelihood function over the set of K segments is given by:

$$ℒ = - \frac{1}{2} {\sum }_{k = 1}^{K} [ log ( 2 π {d}_{k} {f}^{2} ( {\hat{μ}}_{k} \vert c , d , γ ) ) + \frac{{\hat{σ}}_{k}^{2} - f ( {\hat{μ}}_{k} \vert c , d , γ )}{{d}_{k} {f}^{2} ( {\hat{μ}}_{k} \vert c , d , γ )} ] \qquad ( 14 )$$

In practice, as the true value of μ_{K} is not known, we replace μ_{K} with ̂μ_{K} in the logarithm of the likelihood function [symbol] . The maximum likelihood (ML) of the estimations of (c, d, γ) is obtained by maximizing the logarithm of the likelihood function [symbol] :

$$( \hat{c} , \hat{d} , \hat{γ} ) = {arg max}_{( c , d , γ )} ℒ ( c , d , γ ) \qquad ( 15 )$$

To solve the problem of relation (15) we use the procedure of Nelder-Mead (see reference [32]). This procedure requires a starting point (cᵢₙᵢ; dᵢₙᵢ; γᵢₙᵢ). Assuming γᵢₙᵢ=1, to calculate (cᵢₙᵢ; dᵢₙᵢ) with γᵢₙᵢ=1, we take each pair (̂μ_{K1}, ̂σ²_{K1}) and (̂μ_{K2}, ̂σ²_{K2}) and solve the following linear equation system:

$$\{ \begin{matrix}{\hat{σ}}_{{k}_{1}}^{2} = f ( {\hat{μ}}_{{k}_{1}} \vert c , d , {γ}_{ini} ) \\ {\hat{σ}}_{{k}_{2}}^{2} = f ( {\hat{μ}}_{{k}_{2}} \vert c , d , {γ}_{ini} )\end{matrix} \qquad ( 16 )$$

to obtain a solution (C_{k1,k2}; d_{k1,k2}). The value (cᵢₙᵢ; dᵢₙᵢ) is given by the mean of all the possible solutions of (C_{k1,k2}; d_{k1,k2}). The advantage of this procedure is that there is no need to solve a complicated system of partial derivatives with three parameters. Quite obviously, it is difficult to guarantee the convergence of the global solution. To delete the aberrant values of K segments, we use the conventional three-sigma rule (see reference [33]). In fact, we define a mean pixel in each segment Sₖ as follows:

$${\overline{z}}_{k} = \frac{1}{{n}_{k}} {\sum }_{i - 1}^{{n}_{k}} {z}_{k , i} . \qquad ( 17 )$$

As the pixels z_{k,i} of each segment Sₖ are independent and identically distributed, in accordance with Lindeberg's central limit theorem (CLT) [31, theorem 11.2.5], the mean pixel (Zₖ) follows the Gaussian distribution for riₖ large

$${\overline{z}}_{k} \sim 𝒩 ( {μ}_{k} , \frac{{σ}_{k}^{2}}{{n}_{k}} ) \qquad ( 18 )$$

Below the normal, the pixel (Z̅ₖ) is considered to be non-aberrant if the following condition is satisfied: |Z̅K−̂μₖ|≦3\hat{σ}ₖ²/√nₖ. After deleting the aberrant values, all the remaining segments are used for the maximum likelihood (ML) estimation of the parameters.

The application of the theory of hypothesis testing requires the knowledge of the statistical distribution of a pixel. Even if the image Z has undergone non-linear post-acquisition methods and JPEG compression, to simplify the study of the JPEG pixel distribution, we work only on the homogeneous blocks. In accordance with relation (4) hereinabove, the pixel z_{k,i} is rewritten as follows:

z_{k,i}=μₖ+η_{z}^{k,i} (19)

where η_{zk,i} designates the noise after JPEG compression. In fact, the DCT operation used in the JPEG compression scheme is a linear transformation which can approximately decorrelate the input image. Consequently, the noise η_{zk,i} of the spatial domain in the decompressed JPEG image is a linear combination of the independent distributed random variables. By virtue of Lindeberg's central limit theorem (CLT), the marginal distribution of η_{zk,i} is modeled by the zero-mean Gaussian distribution. The variance of the noise η_{zk,i} depends on the expectation of the pixel Pₖ, and follows the generalized noise model (6).

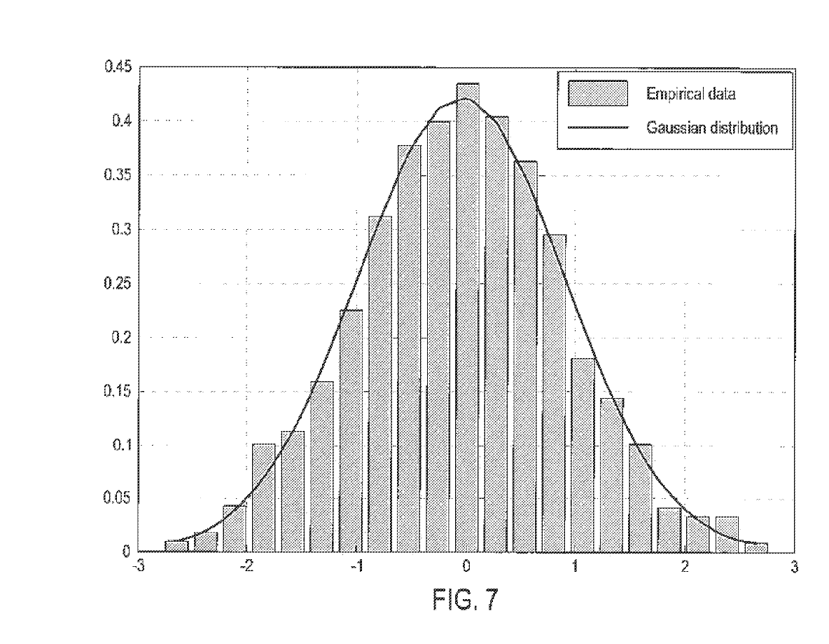

FIG. 7 shows the empirical distribution of the residuals z^{res}_{k,i} in a segment extracted from a natural JPEG image, compared with the theoretical Gaussian distribution. The Gaussian distribution is sufficient to model a pixel as homogeneous segments.

### Formulation of Hypothesis Test

This part makes it possible to analyze two models of photographic cameras 0 and 1. Each photographic camera model j, jε{0,1}, is characterized by three parameters (cⱼ, dⱼ; γⱼ). In a binary hypothesis test, the inspected image Z is either acquired by a photographic camera model 0, or by a photographic camera model 1. The test objective is to decide between two hypotheses defined by: ∀kε{1, . . . , K}, ∀iε{1, . . . , nₖ}

$$\{ \begin{matrix}{ℋ}_{0} = \{ {z}_{k , i} \sim 𝒩 ( {μ}_{k} , {σ}_{k , 0}^{2} ) \} \\ {ℋ}_{1} = \{ {z}_{k , i} \sim 𝒩 ( {μ}_{k} , {σ}_{k , 1}^{2} ) \}\end{matrix} \qquad ( 20 )$$

where (σ²_{k,j}=f{μₖ|cⱼ, dⱼ; γⱼ} is the variance of the noise with respect to the image parameter μₖ under the hypothesis [symbol] ⱼ. As explained previously, the emphasis is placed on a prescribed guarantee of a probability of false alarm. Consequently, by defining

$${𝒦}_{{α}_{0}} = \{ δ \text{:} {sup}_{θ} {ℙ}_{{ℋ}_{0}} [ δ ( Z ) = {ℋ}_{1} ] \leq {α}_{0} \}$$

(20a)
the class of tests with a higher false alarm probability is delimited by α₀. Here P [symbol] _{J}(E) represents the probability of the event E under the hypothesis [symbol] ⱼ with jε{0,1}, θ represents the parameters of the model and the upper bound above θ represents the set of possible values for the parameters of the model. Among all the tests of class Kαo, the aim is to find a test δ which maximizes the power function, defined by the probability of correct detection:

β_{δ}= [symbol] [symbol] _{₁}[δ(Z)= [symbol] ₁] (20b)

Relation (20) demonstrates three fundamental difficulties in the identification of the model of the photographic camera. Firstly, even if all the parameters of the models (μₖ, cⱼ, dⱼ, γⱼ) are known, the most powerful test, namely the LRT, has never been studied for this problem. The second difficulty relates to the image parameters unknown μₖ in practice. Finally, the two hypotheses [symbol] ₀ and [symbol] ₁ are composite because the parameters of the photographic camera (c₀; d₀; γ₀) and (c₁, d₁; γ₁) are unknown.

For the sake of clarity, we assume that the parameter of the photographic camera (c₀; d₀; γ₀) is known and we solve only the problem in which the alternative hypothesis [symbol] ₁ is composite, stated otherwise, the parameters of the photographic camera (c₁; d₁; γ₁) are not known. It should be noted that a test which maximizes the detection power whatever it be (c₁, d₁; γ₁) could exist. Our main objective is to study the LRT test and to design the GLRT test to address the second and the third difficulty. Furthermore, it should be stressed that the GLRT test processed with unknown image parameters, when the parameters of the photographic camera are known, may be interpreted as a closed hypothesis test where a given image is either acquired by the photographic camera model 0, or by the photographic camera model 1. Whereas, the GLRT test processed with the parameters of the unknown photographic camera (c₁, d₁; γ₁) becomes an open hypothesis test in which a given image is acquired by a photographic camera model 0 or not. Indeed, the given image may be acquired by an unknown photographic camera model. Consequently, the two proposed tests may be applied, depending on the requirement of the context.

### Test of the Likelihood Ratio for Two Simple Hypotheses.

When all the parameters of the model are known, by virtue of the Neyman-Pearson lemma [31, theorem 3.2.1], the most powerful test δ which solves the problem (20) is the LRT test proposed by the following decision rule:

$$δ ( Z ) = \{ \begin{matrix}{ℋ}_{0} if Λ ( Z ) = {\sum }_{k = 1}^{K} {\sum }_{i = 1}^{{n}_{k}} Λ ( {z}_{k} ) < τ \\ {ℋ}_{1} if Λ ( Z ) = {\sum }_{k = 1}^{K} {\sum }_{i = 1}^{{n}_{k}} Λ ( {z}_{k} ) \geq τ\end{matrix} \qquad ( 21 )$$

where the decision threshold T is the solution of the following equation:

[symbol]

[symbol]

_{₀}[ [symbol] (Z)≧τ]=α₀ (22)

to ensure that the LRT is in the class [symbol] α₀, the likelihood ratio (LR) of an observation zₖ is defined by

$$Λ ( {z}_{k , i} ) = \frac{1}{2} log ( \frac{{σ}_{k , 0}^{2}}{{σ}_{k , 1}^{2}} ) + \frac{1}{2} ( \frac{1}{{σ}_{k , 0}^{2}} - \frac{1}{{σ}_{k , 1}^{2}} ) {( {z}_{k , i} - {μ}_{k} )}^{2} \qquad ( 23 )$$

In order to analytically establish the statistical performance of the LRT, it is necessary to characterize the statistical distribution of the LR [symbol] (Z) under each hypothesis [symbol] ⱼ. Accordingly, we apply Lindeberg's central limit theorem (CLT) [31, theorem 11.2.5], which makes it necessary to calculate the mean and the variance of [symbol] (z_{k,i}). On the basis of equation (23), the mean and the variance of [symbol] (z_{k,i}) under hypothesis [symbol] ⱼ are given by

$$\begin{matrix}{𝔼}_{{ℋ}_{j}} [ Λ ( {z}_{k , i} ) ] = \frac{1}{2} log ( \frac{{σ}_{k , 0}^{2}}{{σ}_{k , 1}^{2}} ) + \frac{1}{2} ( \frac{1}{{σ}_{k , 0}^{2}} - \frac{1}{{σ}_{k , 1}^{2}} ) {σ}_{k , j}^{2} \\ and & ( 24 ) \\ {Var}_{{ℋ}_{j}} [ Λ ( {z}_{k , i} ) ] = \frac{1}{2} {( \frac{1}{{σ}_{k , 0}^{2}} - \frac{1}{{σ}_{k , 1}^{2}} )}^{2} {σ}_{k , j}^{4} & ( 25 )\end{matrix}$$

where [symbol] [^{•}]) and Va [symbol] [^{•}] designate respectively the expectation and the mathematical variance under the hypothesis [symbol] ⱼ. Finally, the statistical distribution of the LR [symbol] (Z) under hypothesis [symbol] j is given by

$$Λ ( Z ) {\to }^{D} 𝒩 ( {m}_{j} , {υ}_{j} ) \qquad ( 26 )$$

where the notation [symbol] designates convergence toward the distribution and

$$\begin{matrix}{m}_{j} = {\sum }_{k = 1}^{K} \frac{{n}_{k}}{2} [ log ( \frac{{σ}_{k , 0}^{2}}{{σ}_{k , 1}^{2}} ) + ( \frac{1}{{σ}_{k , 0}^{2}} - \frac{1}{{σ}_{k , 1}^{2}} ) {σ}_{k , j}^{2} ] & ( 27 ) \\ {v}_{j} = {\sum }_{k = 1}^{K} \frac{{n}_{k}}{2} {( \frac{1}{{σ}_{k , 0}^{2}} - \frac{1}{{σ}_{k , 1}^{2}} )}^{2} {σ}_{k , j}^{4} & ( 28 )\end{matrix}$$

Given that an image is heterogeneous, it is proposed to normalize the LR [symbol] (Z) so as to fix the decision threshold independently of the content of the image. The normalized LR is defined by

$${Λ}^{*} ( Z ) = \frac{Λ ( Z ) - {m}_{0}}{\sqrt{{v}_{0}}} \qquad ( 29 )$$

Consequently, the corresponding test δ* is rewritten as follows:

$${δ}^{*} ( Z ) = \{ \begin{matrix}{ℋ}_{0} & if {Λ}^{*} ( Z ) < {τ}^{*} \\ {ℋ}_{1} & if {Λ}^{*} ( Z ) \geq {τ}^{*}\end{matrix} \qquad ( 30 )$$

The decision threshold τ* and the power function β_{δ}* are obtained through the following two theorems:

Theorem 1. Assuming that all the parameters of the model (μₖ, cⱼ, dⱼ, γⱼ), kε(1, . . . , k}, j [symbol] {0, 1} are known exactly, for a given level of false-alarm probability α₀, the decision threshold of the test δ* is given by

τ*=Φ⁻¹(1−α₀) (31),

where Φ (^{•}) and Φ⁻¹ (^{•}) designate respectively the Gaussian standard cumulative distribution function of the random variable and its inverse.
This decision threshold guarantees that the false-alarm probability will be equal to α₀, which makes it possible to decide that the photograph does not originate from the photographic camera 0 although this is actually the case.
Theorem 2. The power function of the test δ* is given by:

$${β}_{δ *} = 1 - Φ ( \frac{{m}_{0} - {m}_{1} + {τ}^{*} \sqrt{{v}_{0 }}}{\sqrt{{v}_{1}}} ) \qquad ( 32 )$$

Normalizing the LR [symbol] (Z), allows the test δ* to be applicable to any compressed or non-compressed image, that was subject to the whole set of processings of the acquisition chain, since the normalized LR [symbol] * (Z) follows the standard Gaussian distribution under hypothesis [symbol] ₀. The detection power β_{δ}* serves as upper bound of a statistical test for the problem of identifying the photographic camera. The test δ* makes it possible to justify a prescribed false alarm rate and also maximizes the probability of detection. As its statistical performance is analytically established, it can provide a forecastable analytical result for any probability of false alarm α₀.

### Test of the Generalized Likelihood Ratio

A. Test of the Generalized Likelihood Ratio with the Unknown Parameters of the Image.

The GLRT designed in this paragraph deals with the difficulty wherein the parameters μₖ of the image are unknown by assuming that the parameters of the photographic camera (c₀, d₀, γ₀) and (c₁, d₁, γ₁) are known, i.e. the inspected image Z is either acquired by the photographic camera model 0 or by the model of the photographic camera 1.

As the parameter of the image, μₖ, is not known, we replace μₖ with ̂μₖ defined in (11). As described hereinabove, the variance of ̂μₖ is negligible. Furthermore, to improve the performance of the GLRT, we remove the aberrant pixels z_{k,i} of each segment Sₖ by using the conventional three-sigma rule (see reference [33]). The pixel z_{k,i} is considered to be non-aberrant if the following condition is satisfied: (|z^{res}_{k,i}|≦3σ̂ₖ). This step is iteratively repeated to obtain better estimations of ̂μₖ and of \hat{σ}ₖ². In fact, this method of removing the aberrant values is also performed in the estimation of the parameters of the photographic camera model. After eliminating the aberrant values, all the remaining pixels are used for the proposed tests.

The generalized likelihood ratio (GLR) ̂ [symbol] (z_{k,i}) of an observation z_{k,i} is now given by:

$${\hat{Λ}}_{1} ( {z}_{k , i} ) = \frac{1}{2} log ( \frac{{\hat{σ}}_{k , 0}^{2}}{{\hat{σ}}_{k , 1}^{2}} ) + \frac{1}{2} ( \frac{1}{{\hat{σ}}_{k , 0}^{2}} - \frac{1}{{\hat{σ}}_{k , 1}^{2}} ) {( {z}_{k , i} - {\hat{μ}}_{k} )}^{2} . \qquad ( 33 )$$

where ̂σ²_{k,j}=f(̂μₖ·|·cⱼ, dⱼ, γ_{.j}.). Since the variance of ̂μₖ is negligible, the GLR ̂ [symbol] (Z)=Σ^{K}ᵢ₌₁Σ^{nk}ᵢ₌₁̂ [symbol] (z_{k,i)} also follows the Gaussian distribution with the mean m and the variance v under the hypothesis [symbol] ⱼ

$${\hat{Λ}}_{1} ( Z ) {\to }^{D} ( {m}_{j} , {v}_{j} ) \qquad ( 34 )$$

Consequently, the GLRT ̂δ*₁ based on the normalized GLR ̂ [symbol] *₁(z)=̂ [symbol] (Z)−̂m₀/√̂v₀ defined by:

$${\hat{δ}}_{1}^{*} ( Z ) = \{ \begin{matrix}{ℋ}_{0} & if {\hat{Λ}}_{1}^{*} ( Z ) < {\hat{τ}}_{1}^{*} \\ {ℋ}_{1} & if {\hat{Λ}}_{1}^{*} ( Z ) \geq {\hat{τ}}_{1}^{*}\end{matrix} \qquad ( 35 )$$

Here, ̂m₀ and ̂v₀ are respectively the estimations of m₀ and v₀ by substituting μₖ with ̂μₖ in relations (27) and (28). From the Slutsky theorem (see reference [31, theorem 11.2.11]), it follows that the decision threshold and the power function of the test ̂δ*₁ are given asymptotically by theorems 1 and 2 respectively.
Test of the Generalized Likelihood Ratio with the Image Parameters and the Unknown Parameters of the Photographic Camera.

The GLRT designed in this paragraph deals with the difficulty wherein the parameters μₖ of the inspected image and the parameters of the photographic camera 1 (c₁, d₁, γ₁) are unknown. The parameters (c₀, d₀, γ₀) of the reference photographic camera 0 are considered to be known.

When the parameters of the photographic camera 1, namely (c₁, d₁, γ₁), are not known, the hypothesis [symbol] ₁ becomes composite. The GLRT designed in this paragraph is aimed at verifying whether the inspected image is acquired by the model of the photographic camera 0 or by another model of the photographic camera 1 which is unknown and whose parameters can take arbitrary values. Before designing the GLRT, we perform the maximum likelihood (ML) estimation of the parameters of the photographic camera on the inspected image Z; (see hereinabove). Furthermore, instead of estimating three parameters simultaneously, we put γ₁=γ₀ and the maximization problem of relation (15) is reduced to a problem with two parameters. Let (\ddot{c}₁; ̂d₁) be the solution of this maximization problem, by putting γ₁=γ₀, we are expecting that the inspected image Z was taken by the model of the photographic camera 0. If the image Z was taken by the photographic camera model 0, the parameters (γc₁; γd₁) are in the neighborhood of (c₀; d₀). The maximum likelihood ML estimations (̂c₁; ̂d₁) converge asymptotically to their exact value: ̂c₁ [symbol] c1 and ̂d₁ [symbol] d1. The parameters (c₁, d₁, γ₁) would characterize an unknown photographic camera model. Furthermore, the maximum likelihood (ML) estimations (̂c₁; ̂d₁) exhibit some variability. We denote by (σ²_{c1} σ²_{d1} σ_{c1,d1}) respectively the variance of ĉ₁, the variance of ̂d₁ and the covariance between ̂d₁ and ĉ₁.

The GLR̂ [symbol] ₂(z_{k,i}) of an observation z_{k,i} is now given by:

$${\hat{Λ}}_{2} ( {z}_{k , i} ) = \frac{1}{2} log \frac{f ( {\hat{μ}}_{k} \vert {c}_{0} , {d}_{0} , {γ}_{0} )}{f ( {\hat{μ}}_{k} \vert {\hat{c}}_{1} , {\hat{d}}_{1} , {γ}_{1} )} + \frac{f ( {\hat{μ}}_{k} \vert {\hat{c}}_{1} , {\hat{d}}_{1} , {γ}_{1} ) - f ( {\hat{μ}}_{k} \vert {c}_{0} , {d}_{0} , {γ}_{0} )}{2 f ( {\hat{μ}}_{k} \vert {\hat{c}}_{1} , {\hat{d}}_{1} , {γ}_{1} ) f ( {\hat{μ}}_{k} \vert {c}_{0} , {d}_{0} , {γ}_{0} )} {( {z}_{k , i} - {\hat{μ}}_{k} )}^{2} \qquad ( 36 )$$

In accordance with Slutsky's theorem [31, theorem 11.2.11], the asymptotic mathematical expectation of the GLR̂ [symbol] ₂(Z)=Σ^{K}ᵢ₌₁Σ^{nk}ᵢ₌₁̂ [symbol] (z_{k,i}) under the hypothesis [symbol] ⱼ remains unchanged. Whereas the asymptotic variance of the GLR̂ [symbol] ₂(Z) is necessary to take account of the variability of (̂c₁; ̂d₁). Based on the Delta procedure, see reference [34], we obtain the asymptotic variance of the GLR̂ [symbol] ₂ (z_{k,i}):

$$\begin{matrix}{Var}_{{ℋ}_{j}} = [ {\hat{Λ}}_{2} ( {z}_{k , i} ) ] = \frac{1}{2} {( \frac{1}{{σ}_{k , 0}^{2}} - \frac{1}{{σ}_{k , 1}^{2}} )}^{2} {σ}_{k , j}^{4} \\ + \frac{1}{4} \frac{Var [ f ( {\hat{μ}}_{k} \vert {\hat{c}}_{1} , {\hat{d}}_{1} , {γ}_{1} ) ]}{{σ}_{k , 1}^{4}} \\ + \frac{3}{4} \frac{Var [ f ( {\hat{μ}}_{k} \vert {\hat{c}}_{1} , {\hat{d}}_{1} , {γ}_{1} ) ]}{{σ}_{k , 1}^{8}} {σ}_{k , j}^{4}\end{matrix} \qquad ( 37 )$$

where the variance Var[̂²_{k,j}=f(̂μₖ·|·ĉ₁; \hat{d}₁, γ_{,1}.)] is given by

$$Var [ f ( {\hat{μ}}_{k} \vert {\hat{c}}_{1} , {\hat{d}}_{1} , {γ}_{1} ) ] = \frac{{μ}_{k}^{4 - 2 {γ}_{1}}}{{γ}_{1}^{4}} {σ}_{{c}_{1}}^{2} + \frac{{μ}_{k}^{4 - 4 {γ}_{1}}}{{γ}_{1}^{4}} {σ}_{{d}_{1}}^{2} + 2 \frac{{μ}_{k}^{4 - 3 {γ}_{1}}}{{γ}_{1}^{4}} {σ}_{c 1 {d}_{1}} \qquad ( 38 )$$

The second and the last terms of relation (37) take account of the variability of (̂c₁; ̂₁) and of the variance of the GLR̂ [symbol] ₂ (z_{k,i}).

Consequently, the asymptotic variance of the GLR̂ [symbol] ₂ (Z) is simply the sum of all the ̂ [symbol] ₂ (z_{k,i})

$${\tilde{v}}_{j} = {Var}_{{ℋ}_{j}} [ {\hat{Λ}}_{2} ( Z ) ] = {\sum }_{k = 1}^{K} {n}_{k} {Var}_{{ℋ}_{j}} [ {\hat{Λ}}_{2} ( {z}_{k , i} ) ] \qquad ( 39 )$$

Likewise, by virtue of Lindeberg's central limit theorem (CLT), the GLR̂ [symbol] ₂ (Z) follows the Gaussian distribution under the hypothesis [symbol] ⱼ

$${\hat{Λ}}_{2} ( Z ) {\to }^{D} ( {m}_{j} , {\tilde{v}}_{j} ) \qquad ( 40 )$$

This makes it possible to design the GLRT ̂δ*₂ on the basis of the normalized GLR̂ [symbol] *₁(Z)=̂ [symbol] (Z)−̂m₀/√̂v₀

$${\hat{δ}}_{2}^{*} ( Z ) = \{ \begin{matrix}{ℋ}_{0} & if {\hat{Λ}}_{2}^{*} ( Z ) < {\hat{τ}}_{2}^{*} \\ {ℋ}_{1} & if {\hat{Λ}}_{2}^{*} ( Z ) \geq {\hat{τ}}_{2}^{*}\end{matrix} \qquad ( 41 )$$

where ̂m₀ and ˜̂v₀ are obtained by replacing ̂Pₖ, c₁; d₁ with ̂μₖ, ̂c₁; ̂d₁ respectively. The decision threshold and the power function of the GLRT ̂δ*₂ are given by the following two theorems.

Theorem 3. When the inspected image Z is acquired by the model of the photographic camera 0, characterized by the parameters (c₀; d₀;γ₀), for a given level of false-alarm probability α₀, the decision threshold of the GLRT γδ*₂ is given by:

\hat{τ}₂*=Φ⁻¹(1−α₀) (42)

This decision threshold guarantees that the false-alarm probability will be equal to α₀, thereby making it possible to decide that the photograph does not originate from the photographic camera 0 although this is actually the case.

Theorem 4 The power function of the GLRT ̂δ*₂ is given by

$${β}_{{\hat{δ}}_{2}^{*}} = 1 - Φ ( \frac{{m}_{0} - {m}_{1} + {\hat{τ}}_{2}^{*} \sqrt{{\tilde{v}}_{0}}}{\sqrt{{\tilde{v}}_{1}}} ) . \qquad ( 43 )$$

### Numerical Experiments

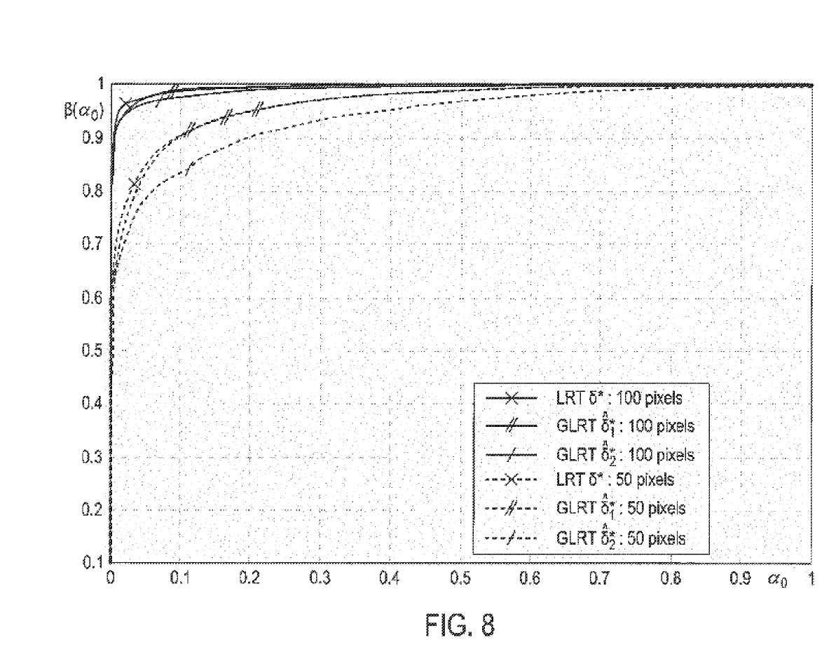

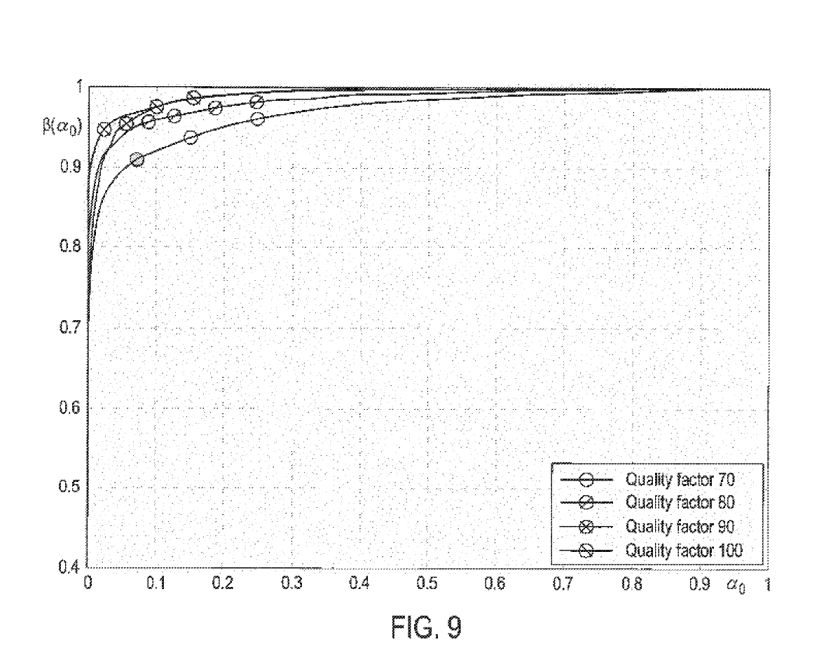

The detection performance of the proposed tests is firstly carried out theoretically on a simulation database. The photographic camera models 0 and 1 are respectively characterized by (c₀; d₀; γ₀)=(−0.0012, 0.11, 0.8) and (c₁; d₁; γ₀)=(−0.0025, 0.20, 0.85). These parameters correspond respectively to the Nikon D70 and Nikon D200 photographic camera models in the Dresden image database (cf. [25], see FIG. 6). The camera's photographic parameters are used to randomly generate 5000 images for the model of the photographic camera 0 and 5000 images for the model of the photographic camera 1, which are compressed with various quality factors. The results are presented in FIGS. 8 and 9 respectively for a distinct number of pixels, chosen randomly in the image (FIG. 8), and for various quality factors (FIG. 9).

Furthermore, the implementation of the GLRT ̂δ*₂ requires that the covariance matrix of the maximum likelihood (ML) estimations (̂c₁; ̂d₁) be known. However, the maximum likelihood ML estimations (̂c₁; ̂d₁) are given numerically, thus giving rise to a difficulty in defining the covariance matrix. To simplify this problem, we estimate (̂c; ̂d) on each image on the basis of M=50 images which are taken by the model of the photographic camera 0. Thereafter, we estimate the covariance matrix of the M previous pairs (̂c; ̂d). Very exactly, it is the covariance matrix which characterizes the variability of (c₀; d₀) in practice. By implementing the GLRT ̂δ*₂, we are expecting that the parameters (̂c₁; ̂d₁) fall in the neighborhood of (c₀; d₀), namely that the inspected image Z was acquired by the photographic camera model 0. This leads us to utilize this covariance matrix in the implementation of the GLRT ̂δ*₂. This step is also carried out in the test with the real images.

FIG. 8 represents the detection performance of the proposed tests for various numbers of pixels. The probability of correct detection β_{δ} of each test is represented as a function of the false alarm probability α₀ (curves of “operational reception characteristic” or ORC). The very low power loss between the LRT δ* and the GLRT ̂δ*₁ demonstrates the precision of the proposed estimation algorithm. Furthermore, it is seen in this FIG. 8 that the power loss between the GLRT ̂δ*₁ and the GLRT ̂δ*₂ decreases as the number of pixels increases. For only 50 pixels, sufficient statistics do not exist for convergence according to Lindeberg's central limit theorem (CLT).

FIG. 9 shows the detection performance of the GLRT ̂δ*₂ for various quality factors. As forecast, the probability of correct detection β_{δ} decreases with the reduction in the quality factor. In fact, the fact of randomly selecting a certain number of pixels (i.e. 50 and 100 pixels) for the proposed tests allows better visibility since their power function is perfect, for example, for various quality factors of only 500 pixels, β_{δ}=1. In contradistinction to the procedures which utilize all the pixels, the procedure proposed in the present invention requires only a small number of pixels to achieve perfect detection performance.

It is important to recall that the proposed GLRT tests are designed within the framework of the theory of hypothesis testing where the parameters of the reference photographic camera (c₀; d₀; γ₀) under the hypothesis [symbol] _{O} are assumed to be known in advance. Consequently, these parameters must be precisely defined in practice. Accordingly, we use M=50 images and the parameters (c, d, γ) are extracted from each image. The reference parameter γ₀ is calculated as the mean of the M estimated gamma values. Thereafter, we re-estimate the parameters (c, d) in each image by setting the parameter γ equal to the mean γ₀. The maximization problem of relation (15) with three parameters reduces again to a relation with two parameters. The variability of the parameters (c, d) can also be decreased. The reference parameters (c₀, d₀) are finally obtained by taking the mean of the previous estimations (c,d). Obviously, the use of a bigger number of images makes it possible to obtain a better estimation, but it is also less realistic. The number of 50 images is a good compromise.

To demonstrate the relevance of the proposed GLRT tests, two photographic camera models, Nikon D70 and Nikon D200 from the Dresden image database [25], are chosen to conduct the experiment since two models of photographic cameras of the same brand may exhibit similar characteristics. Only the red color channel is used in this experiment. The Nikon D70 and Nikon D200 photographic cameras are respectively fixed at [symbol] ₀ and [symbol] ₁. The parameters of the reference camera are estimated as described hereinabove.

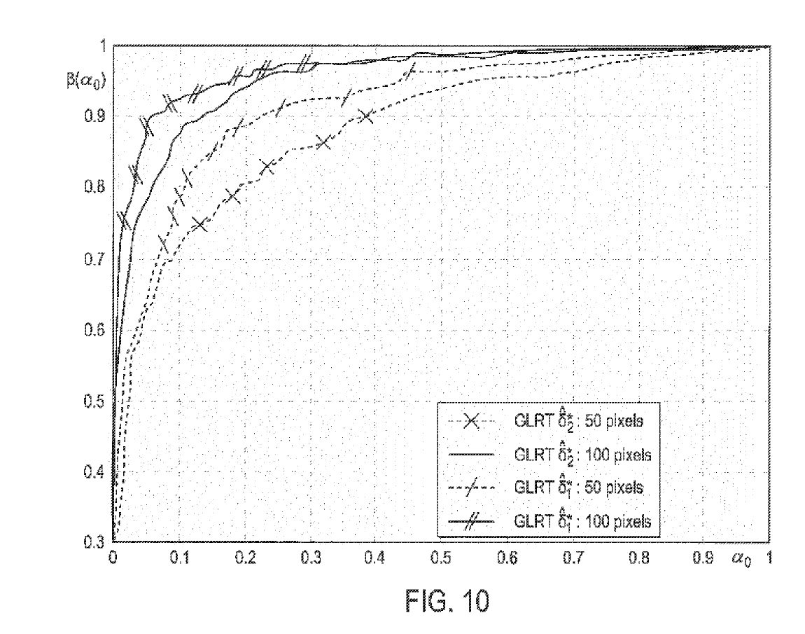

FIG. 10 shows the detection performance of the GLRT ̂δ*₁ and ̂δ*₂ for various numbers of pixels. Behavior similar to the ORC curves of FIG. 9, arising from the simulated database, may be noted. A small power loss exists between the two power functions since the GLRT test ̂δ*₂ takes into account the various estimations (̂c₁; ̂d₁) which are influenced by the content of the image. Nonetheless, the two GLRT tests proposed on the basis of 500 pixels are almost perfect.

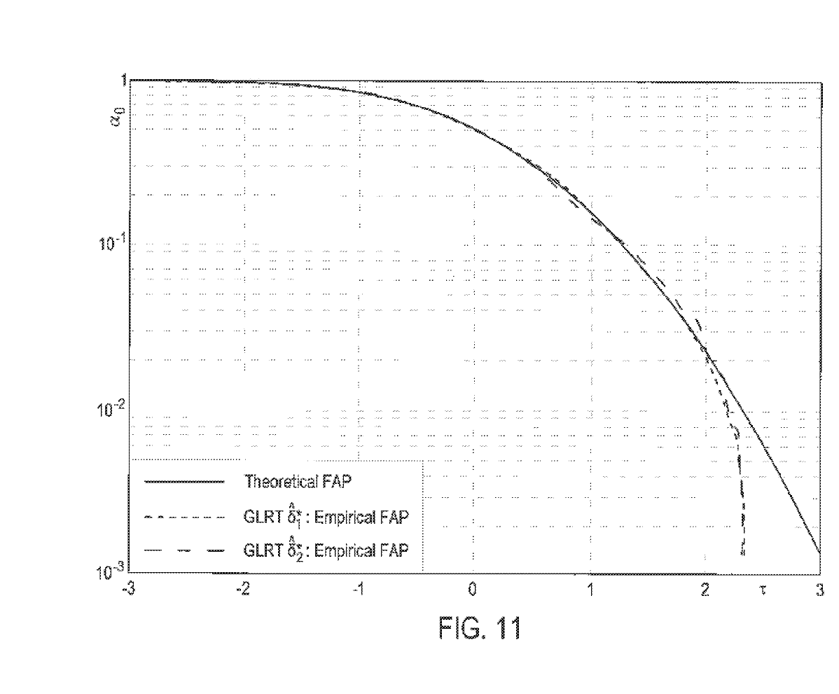

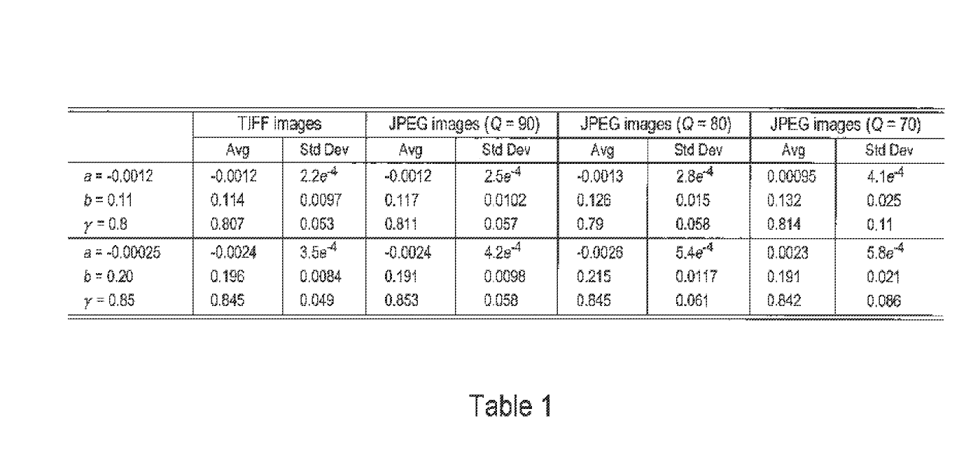

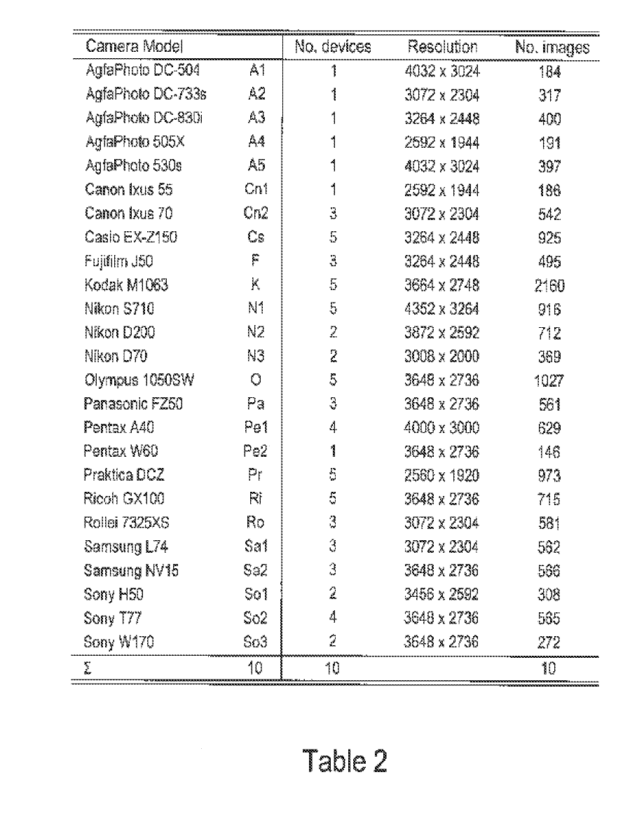

FIG. 11 shows the comparison between the theoretical and empirical false alarm probabilities which are plotted as a function of the decision threshold τ. The two GLRT tests ̂δ*₁ and ̂δ*₂ proposed show a capacity to guarantee a prescribed false alarm rate, even though there is a slight difference in certain cases (typically when α₀≦10⁻³) because of the influence of the content of the image, of the presence of the weak aberrations which cannot be detected by the pixels selection method hereinabove, and of the relative inaccuracy of Lindeberg's central limit theorem (CLT) for low probabilities (or distribution tails).

### Results on a Large Database

The experiments are conducted on a large database to verify the efficiency of the proposed procedure. The Dresden public image database [25] is chosen for our experiments. The technical characteristics of the photographic cameras are presented in table 2, see more details in [25]. The database covers the various devices by photographic camera model, various imaged scenes, various photographic camera settings and different environmental conditions. All the images are acquired with the highest JPEG quality and a maximum available resolution.

The proposed procedure can be extended to images arising from a video stream. A video stream is composed of a succession of images which file past at a fixed tempo. Video compression is a data compression procedure which consists in reducing the quantity of data, while minimizing the impact on the visual quality of the video. The benefit of video compression is to reduce the costs of storing and transmitting video files. Video sequences contain very great statistical redundancy, both in the temporal domain and in the spatial domain. The fundamental statistical property on which compression techniques are based is correlation between pixels. This correlation is both spatial, the adjacent pixels of a current image are similar, and temporal, the pixels of the past and future images are also very close to the current pixel. Video compression algorithms of MPEG type use the DCT (discrete cosine transform) transformation on blocks of 8×8 pixels, to efficiently analyze the spatial correlations between neighboring pixels of the same image. Thus, in the method according to the invention the photograph may be an image arising from a video stream and compressed according to the MPEG standard.

It is possible to envisage another case of using the system to identify a photographic camera model with a view to determining whether a zone of the image has not been falsified, by copying/pasting from another photograph or by deletion of an element.

Finally, another case of using the system for identifying a photographic camera model with a view to determining, in a supervised manner, whether a zone of the image has not been falsified (by copying/pasting from another photograph or by deletion of an element). Here, “supervised” is intended to mean the fact that the user wishes to make sure of the integrity of a previously defined zone. The principle is then to apply the identification procedure to the two “sub-images” arising respectively from the zone targeted by the user and from the complementary zone (the remainder of the image). If the inspected element originates from another photograph and has been added by copying/pasting, the noise properties will be different, something that the proposed system will be capable of identifying (by assuming that the photographs were not taken under the same acquisition conditions and with the same photographic camera model, which seems reasonable).

The proposed procedure for identifying the photographic camera model addresses the two weaknesses of the procedures briefly presented in the prior art: 1) their performance is not established and, 2) these procedures can be foiled by the calibration of the photographic camera. The proposed procedure relying on the noise properties inherent in the acquisition of compressed photographs, it is applicable whatever the post-acquisition processings applied by a user (in particular with a view to improving visual quality). Furthermore, the parametric modeling of the statistical distribution of the value of the pixels in the spatial domain makes it possible to analytically provide the performance of the proposed test. This advantage makes it possible in particular to ensure compliance with a prescribed constraint on the probability of error.

The main fields of application of the invention are on the one hand, the search for proof on the basis of a “compromising” image and, on the other hand, the guarantee that a photograph was acquired by a given photographic camera.

The proposed procedure can be extended to checking the integrity of a photograph. The aim is then to guarantee that a photograph has not been modified/falsified since its acquisition. This makes it possible for example to detect photographs comprising elements originating from a different photographic camera, i.e. imported after acquisition, or else to ensure the integrity of a scanned or photographed document (a legal document for example).

The method of the invention will be able to be developed in specialized software from software manufacturers, in the search for proof on the basis of digital media. The method according to the invention can be used in court with a view to providing a decision aid tool.

### REFERENCES

[1] H. Farid, “A survey of image forgery detection,” IEEE Signal Processing Magazine, vol. 2, no. 26, pp. 16-25, March 2009.
[2] R. Ramanath, W. E. Snyder, Y. Yoo, and M. S. Drew, “Color image processing pipeline,” Signal Processing Magazine, IEEE, vol. 22, no. 1, pp. 34-43, January 2005.
[3] J. Nakamura, Image Sensors and Signal Processing for Digital Still Cameras. CRC Press, 2005.
[4] T. H. Thai, R. Cogranne, and F. Retraint, “Statistical model of natural images,” in Image Processing, International Conference on, September 2012, pp. 2525-2528.
[5] K. S. Choi, E. Y. Lam, and K. Wong, “Source camera identification using footprints from lens aberration,” in Proc. of the SPIE, vol. 6069, February 2006, pp. 172-179.
[6] A. Swaminathan, M. Wu, and K. J. R. Liu, “Nonintrusive component forensics of visual sensors using output images,” Information Forensics and Security, IEEE Transactions on, vol. 2, no. 1, pp. 91-106, March 2007.
[7] H. Cao and A. C. Kot, “Accurate detection of demosaicing regularity for digital image forensics,” Information Forensics and Security, IEEE Transactions on, vol. 4, no. 4, pp. 899-910, December 2009.
[8] A. Swaminathan, M. Wu, and K. J. R. Liu, “Digital image forensics via intrinsic fingerprints,” Information Forensics and Security, IEEE Transactions on, vol. 3, no. 1, pp. 101-117, March 2008.
[9] K. S. Choi, E. Y. Lam, and K. K. Y. Wong, “Source camera identification by JPEG compression statistics for image forensics,” in TENCON, IEEE Region 10 Conference, November 2006, pp. 1-4.
[10] Z. Deng, A. Gijsenij, and J. Zhang, “Source camera identification using auto-white balance approximation,” in Computer Vision, IEEE International Conference on, November 2011, pp. 57-64.
[11] C. Scott, “Performance measures for Neyman-Pearson classification,” Information Theory, IEEE Transactions on, vol. 53, no. 8, pp. 2852-2863, August 2007.
[12] J. Lukas, J. Fridrich, and M. Goljan, “Digital camera identification from sensor pattern noise,” Information Forensics and Security, IEEE Transactions on, vol. 1, no. 2, pp. 205-214, June 2006.
[13] M. Chen, J. Fridrich, M. Goljan, and J. Lukas, “Determining image origin and integrity using sensor noise,” Information Forensics and Security, IEEE Transactions on, vol. 3, no. 1, pp. 74-90, March 2008.
[14] M. Goljan, J. Fridrich, and T. Filler, “Large scale test of sensor fingerprint camera identification,” in Proc. SPIE, Electronic Imaging, Security and Forensics of Multimedia Contents, vol. 7254, January 2009, pp. 18-22.
[15] C.-T. Li, “Source camera identification using enhanced sensor pattern noise,” Information Forensics and Security, IEEE Transactions on, vol. 5, no. 2, pp. 280-287, June 2010.
[16] X. Kang, Y. Li, Z. Qu, and J. Huang, “Enhancing source camera identification performance with a camera reference phase sensor pattern noise,” Information Forensics and Security, IEEE Transactions on, vol. 7, no. 2, pp. 393-402, April 2012.
[17] C.-T. Li and Y. Li, “Color-decoupled photo response non-uniformity for digital image forensics,” Circuits and Systems for Video Technology, IEEE Transactions on, vol. 22, no. 2, pp. 260-271, February 2012.
[18] T. Filler, J. Fridrich, and M. Goljan, “Using sensor pattern noise for camera model identification,” in Image Processing, IEEE International Conference on, October 2008, pp. 1296-1299.
[19] K. Kurosawa, K. Kuroki, and N. Saitoh, “CCD fingerprint methodidentification of a video camera from videotaped images,” in Image Processing, International Conference on, vol. 3, October 1999, pp. 537-540.
[20] T. Gloe, M. Kirchner, A. Winkler, and R. B\ddot{} ohme, “Can we trust digital image forensics?” in International Conference on Multimedia, 2007, pp. 78-86.
[21] F. Retraint and R. Cogranne, “Système pour déterminer l'identification d'un appareil photographique à partir d'une photographie et procédémis en oeuvre dans un tel système”. Brevet Français, Numéro de publication INPI FR 2987923.
[22] B. Widrow, I. Kollar, and M.-C. Liu, “Statistical theory of quantization,” Instrumentation and Measurement, IEEE Transactions on, vol. 45, no. 2, pp. 353-361, April 1996.
[23] H. Faraji and W. J. MacLean, “CCD noise removal in digital images,” Image Processing, IEEE Transactions on, vol. 15, no. 9, pp. 2676-2685, September 2006.
[24] X. Liu, M. Tanaka, and M. Tokunomi, “Estimation of signal dependent noise parameters from a single image,” in Image Processing, International Conference on, September 2013, pp. 79-82.
[25] T. Gloe and R. Bohme, “The ‘dresden image database’ for benchmarking digital image forensics,” Proceedings of the ACM symposium on Applied computing, vol. 2, pp. 1585-1591, 2010.
[26] N. Ponomarenko, V. Lukin, A. Zelensky, K. Egiazarian, M. Carli, and F. Battisti, “TID2008—a database for evaluation of full-reference visual quality assessment metrics,” Advances of Modem Radioelectronics, vol. 10, pp. 30-45, 2009.
[27] R. P. Kleihorst, R. L. Lagendiik, and J. Biemond, “An adaptive order-statistic noise filter for gamma-corrected image sequences,” Image Processing, IEEE Transactions on, vol. 6, no. 10, pp. 1442-1446, October 1997.
[28] H. Farid, “Blind inverse gamma correction,” Image Processing, IEEE Transactions on, vol. 10, no. 10, pp. 1428-1433, October 2001.
[29] A. Foi, M. Trimeche, V. Katkovnik, and K. Egiazarian, “Practical poissonian-gaussian noise modeling and fitting for single-image raw data,” Image Processing, IEEE Transactions on, vol. 17, no. 10, pp. 1737-1754, October 2008.
[30] M. K. Mihak, I. Kozintsev, and K. Ramchandran, “Spatially adaptive statistical modeling of wavelet image coefficients and its application to denoising,” in Acoustics, Speech, and Signal Processing, IEEE International Conference on, vol. 6, March 1999, pp. 3253-3256.
[31] E. L. Lehmann and J. P. Romano, Testing Statistical Hypotheses, 3rd ed. New York: Springer, 2005.
[32] J. A. Nelder and R. Mead, “A simplex method for function minimization,” The Computer Journal, vol. 7, pp. 308-313, 1965.
[33] F. R. Hampel, “The influence curve and its role in robust estimation,” Journal of the American Statistical Association, no. 69, pp. 382-393, June 1974.
[34] A. Stuart and J. K. Ord, Kendall's Advanced Theory of Statistics, 6th ed. Arnold, 1994, vol. 1

1-10. (canceled)

11. A system for identifying a photographic camera model on the basis of a photograph in the form of a compressed or uncompressed image in the TIFF format, the photograph obeying a relation between the expectation and the variance of the pixels such that:
$${σ}_{{z}_{1}}^{2} = \frac{1}{{γ}^{2}} {μ}_{{z}_{i}}^{2 - 2 γ} ( c {μ}_{{z}_{i}}^{γ} + d ) + \frac{{Δ}^{2}}{12}$$
where zᵢ is the pixel, Δ is the step size, fixed by the photographic camera, of a quantization of the photograph, μ_{zi} and σ_{zi}² designate respectively the expectation and the mathematical variance of a pixel zᵢ, γ is the gamma correction parameter, fixed by the photographic camera, and the parameters (c, d) of the relation determine fingerprints characterizing the photographic camera model, the system comprising:
an image processing device to process the photograph to estimate parameters c and d;
a device for executing statistical hypothesis tests on a distribution of pixels of the photograph; and
a statistical analysis device to determine whether the photograph has been taken by the photographic camera model by comparing the parameters c and d arising from the photograph and the known parameters c and d of the photographic camera model.

12. The system according to claim 11, wherein the analysis device provides an indication about the identification of the photographic camera model by certifying accuracy of identification with a previously defined precision.

13. A method implemented in the system according to claim 12 comprising:
prior analysis of at least one photograph acquired with a known photographic camera model to estimate print parameters c and d of the photographic camera model,
reading of a photograph in the form of a compressed image to determine the matrices of the value of the pixels,
estimating a generalized noise model for the compressed image, by taking account of the gamma correction parameter,
estimating parameters of the generalized noise model, detection of the contours, and segmentation of the compressed image,
executing statistical hypothesis tests to identify the photographic camera model.

14. The method according to claim 13 wherein statistical hypothesis tests are executed as a function of a prescribed constraint on a probability of error.

15. The method according to claim 13, wherein the photograph is a compressed image according to a JPEG compression standard and derives from a photographic camera or from a scanner.

16. The method according to claim 13, wherein the photograph is a reference image or inter-frame image belonging to a video stream and compressed according to an MPEG compression standard.

17. The method according to claim 15 further comprising detecting in a non-supervised manner falsification of a zone of a photograph.

18. The method according to claim 15 further comprising detecting detection in a supervised manner falsification of a zone of a photograph.

19. The method according to claim 15 further comprising searching for proofs on a basis of a compromising photograph.

20. The method according to claim 15 further comprising searching for proofs on a basis of digital media.
